(19) United States
(12) Patent Application Publication
(10) Pub. No.: US 2009/0156777 A1
(43) Pub. Date: Jun. 18, 2009

(54) Freeze-stable aromatic diisocyanates and processes for the preparation of these freeze-stable products

(76) Inventors: Neil H. Nodelman, Upper St. Clair, PA (US); Ulrich B. Holeschovsky, Mt. Lebanon, PA (US); Kurt E. Walter, Pittsburgh, PA (US); Dennis F. Yajko, Churchill, PA (US)

Correspondence Address: BAYER MATERIAL SCIENCE LLC, 100 BAYER ROAD, PITTSBURGH, PA, 15205, US

(21) Appl. No.: 12/002,435

(22) Filed: Dec. 17, 2007

(51) Int. Cl. C08G 18/72

(52) U.S. Cl. 528/44

(57) ABSTRACT

This invention relates to freeze-stable aromatic diisocyanates, an to processes for the preparation of these freeze-stable aromatic diisocyanates. The preferred aromatic diisocyanate is preferably diphenylmethane diisocyanate. These freeze-stable aromatic diisocyanates comprise a blend of an aromatic diisocyanate, with 2,2,4-trimethyl-1,3-pentanediol diisobutyrate, and have an NCO group content of from about 6% to about 29% by weight. Suitable aromatic diisocyanates contain one or more of the following modifying groups: allophanate groups, carbodiimide groups, uretonimine groups, biuret groups, dimer groups, isocyanurate groups, urea groups and/or urethane groups. Prepolymers of these modified aromatic diisocyanates are also suitable for the present invention.

### BACKGROUND OF THE INVENTION

This invention relates to freeze stable aromatic diisocyanates, freeze-stable aromatic diisocyanate prepolymers, and to processes for the preparation of these freeze-stable products.

Diisocyanates that are liquid at room temperature have numerous advantages over solid diisocyanates. The most commercially important diisocyanates are 4,4′-diphenyl-methane diisocyanate, which is a solid at room temperature, 2,4′-diphenylmethane diisocyanate and the toluene diisocyanate isomers. Numerous patents have issued relating to the liquifaction of 4,4′-diphenylmethane diisocyanate (MDI).

One common route to liquifaction of 4,4′-MDI is through carbodiimidizations. Typical of this route are the processes described in, for example, U.S. Pat. Nos. 3,152,162, 3,384,653, 3,449,256, 3,640,966, 3,641,093, 3,701,796, 4,014,935 4,088,665, 4,154,752 and 4,177,205.

The most common technique to liquify MDI is through the reaction with various hydroxyl functional materials. The prior art has described numerous types of liquid isocyanates. These include both (1) reaction products of (i) MDI or modified MDI with (ii) hydroxyl functional materials such as are described in, for example, U.S. Pat. Nos. 3,644,457, 3,883,571, 4,229,347, 4,055,548, 4,102,833, 4,115,429, 4,118,411, 4,332,742, 4,448,904, 4,490,300, 4,490,301, 4,490,302, 4,539,156, 4,539,158, 4,883,909, 4,442,235 and 4,910,333, as well as (2) mixtures of (i) a reaction product of MDI or modified MDI and hydroxyl functional materials, with (ii) MDI, PMDI or modified MDI, such as are described in, for example, U.S. Pat. Nos. 4,031,026, 4,261,852, 4,321,333, 5,240,635 and 5,246,977.

It is also known to introduce allophanate-linkages into polyisocyanates. This is described in various patents including, for example, U.S. Pat. Nos. 4,738,991, 4,866,103, 5,319,053, 5,319,054, 5,440,003, 5,663,272, 5,610,260 and 5,783,652, and GB Patent 994,890. These products are commonly referred to as allophanate-modified isocyanates.

U.S. Pat. Nos. 6,242,556 and 6,482,913 describe liquid MDI adducts which exhibit improved freeze stability. U.S. Pat. No. 6,242,556 discloses a blend of (A) an MDI adduct having an NCO group content of 15 to 30% and prepared by reacting MDI of the specified isomer distribution with a low molecular weight branched aliphatic compound that contains two hydroxyl groups; and (B) an allophanate-modified MDI having an NCO group content of 12 to 32.5% and prepared by reacting MDI of the specified isomer distribution with an aliphatic alcohol. The freeze-stable adducts of U.S. Pat. No. 6,482,913 comprise (A) an allophanate-modified MDI having an NCO group content of 16 to 32.5%, (B) a low molecular weight branched aliphatic compound having two hydroxyl groups, and (C) from 0.01 to 1% by weight, based on the combined weight of (A) and (B), of an epoxide functional compound.

Various polyurethane plasticizers are known and described in, for example U.S. Pat. Nos. 6,218,462, 6,355,721, 6,384,130 and 6,403,702. These patents all disclose that the plasticizers are non-migrating and suitable for the production of conventional polyurethanes.

Advantages of the present invention include low temperature stability (i.e. freeze-stability) of the resultant isocyanates, combined with improved MDI dimer solubility.

### SUMMARY OF THE INVENTION

This invention relates to freeze-stable aromatic diisocyanate compositions and a process for their preparation.

The freeze-stable aromatic diisocyanate compositions have an NCO group content of about 6 to about 29% by weight. These compositions comprise:
(I) from 60 to 95%, preferably from 70 to 90%, by weight, based on 100% by weight of (I) and (II), of an aromatic diisocyanate which is modified to contain at least one of the following groups: allophanate groups, carbodiimide groups, uretonimine groups, biuret, dimer, isocyanurate (trimer), urea and/or urethane, in which the modified diisocyanate has an NCO group content of from 15% to 30% by weight, and/or polyether or polyester polyol prepolymers of an aromatic diisocyanate which is modified to contain at least one of the following groups: allophanate groups, carbodiimide groups, uretonimine groups, biuret, dimer, isocyanurate (trimer), urea and/or urethane, in which the prepolymer has an NCO content of from 10% to 28% by weight;
and
(II) from 5 to 40%, preferably 10 to 30%, by weight, based on 100% by weight of (I) and (II), of 2,2,4-trimethyl-1,3-pentanediol diisobutyrate.

In a preferred embodiment, the aromatic diisocyanate (I) comprises an allophanate-modified diphenylmethane diisocyanate having an NCO group content of from 18 to 30%, preferably from 23 to 30% by weight, and which comprises the reaction product of:
a) diphenylmethane diisocyanate that comprises (i) from 0 to 23% by weight of the 2,4′-isomer, (ii) from 0 to 3% by weight of the 2,2′-isomer and (iii) from 74 to 100% by weight of the 4,4′-isomer, with the sum of the %'s by weight of (a)(i), (a)(ii) and (a)(iii) totaling 100% by weight of (a),
and
(b) an aliphatic alcohol or an aromatic alcohol, wherein the alcohol contains up to about 22 carbon atoms.

Another aspect of the present invention is freeze-stable prepolymers of allophanate-modified diphenylmethane diisocyanates. These freeze-stable prepolymers comprise:
(I) from 60 to 95% by weight, preferably from 70 to 90% by weight, based on 100% by weight of (I) and (II), of a prepolymer of an allophanate-modified diphenylmethane diisocyanate having an NCO group content of 10 to 28% and which is the reaction product of:
   (A) an allophanate-modified diphenylmethane diisocyanate having an NCO group content of from 18 to 30%, preferably from 23 to 30% by weight, and which comprises the reaction product of:
      (a) diphenylmethane diisocyanate that comprises from 0 to 23% by weight of the 2,4-isomer, from 0 to 3% by weight of the 2,2′-isomer and from 74 to 100% by weight of the 4,4′-isomer, with the sum of the %'s by weight of the 2,4′-, the 2,2′- and the 4,4′-isomers totaling 100% by weight of (a),
      and
      (b) an aliphatic alcohol or an aromatic alcohol, wherein the alcohol contains up to about 22 carbon atoms;
   with
   (B) a polyether polyol containing from 1 to 6 hydroxyl groups and having a molecular weight of from 1,000 to 12,000, in which the polyether polyol is prepared from a suitable starter compound with ethylene oxide and propylene oxide in a weight ratio of 0:100 to 35:65;
and
(II) from 5 to 40% by weight, preferably from 10 to 30% by weight, based on 100% by weight of (I) and (II), of 2,2,4-trimethyl-1,3-pentanediol diisobutyrate.

In another embodiment, the freeze-stable aromatic diisocyanates of the invention comprise
(I) from 60 to 95% by weight, preferably from 70 to 90% by weight, based on 100% by weight of (I) and (II), of a carbodiimide-modified diphenylmethane diisocyanate having an NCO group content of 23% to 30% by weight;
and
(II) from 5 to 40% by weight, preferably from 10 to 30% by weight, based on 100% by weight of (I) and (II), of 2,2,4-trimethyl-1,3-pentanediol diisobutyrate.

The invention also relates to a process of preparing these freeze-stable isocyanate compositions. This process comprises:
(1) blending
   (I) from 60% to 95%, preferably 70 to 90 by weight, based on 100% by weight of (I) and (II), of an aromatic diisocyanate as described above and having an NCO group content of 10% to 30% by weight;
   with
   (II) from 5 to 40%, preferably 10 to 30% by weight, based on 100% by weight of (I) and (II), of 2,2,4-trimethyl-1,3-pentanediol diisobutyrate.

The process of preparing the freeze-stable, allophanate-modified diphenylmethane diisocyanate compositions comprises:
(1) blending
   (I) from 60% to 95% by weight, preferably 70 to 90 by weight, based on 100% by weight of (I) and (II), of an allophanate-modified diphenylmethane diisocyanate as described above and having an NCO group content of 18% to 30%;
   with
   (II) from 5 to 40% by weight, preferably 10 to 30% by weight, based on 100% by weight of (I) and (II), of 2,2,4-trimethyl-1,3-pentanediol diisobutyrate.

The process of preparing the freeze-stable prepolymers of the allophanate-modified diphenylmethane diisocyanate compositions comprises:
(1) blending
   (I) from 60 to 95% by weight, preferably 70 to 90 by weight, based on 100% by weight of (I) and (II), of a prepolymer of an allophanate-modified diphenylmethane diisocyanate as described above and having an NCO group content of 10% to 28%;
   with
   (II) from 5 to 40% by weight, preferably 10 to 30% by weight, based on 100% by weight of (I) and (II), of 2,2,4-trimethyl-1,3-pentanediol diisobutyrate.

The process of preparing the freeze-stable carbodiimide-modified isocyanate compositions comprises:
(1) blending
   (I) from 60 to 95% by weight, preferably 70 to 90 by weight, based on 100% by weight of (I) and (II), of a carbodiimide-modified diphenylmethane diisocyanate as described above and having an NCO group content of 23% to 30%;
   with
   (II) from 5 to 40% by weight, preferably 10 to 30% by weight, based on 100% by weight of (I) and (II), of 2,2,4-trimethyl-1,3-pentanediol diisobutyrate.

### DETAILED DESCRIPTION OF THE INVENTION

As used herein with respect to the polyisocyanate compositions of the invention, the term freeze-stable means that the polyisocyanate compositions herein do not become cloudy and/or precipitate solids at temperatures up to 10° C. below the freezing temperature of the neat (unblended) isocyanate, for a period of at least 28 days, preferably at least two (2) months, more preferably at least three (3) months, and most preferably at least six (6) months.

In addition, once the polyisocyanate compositions have been frozen, the compositions can be heated to form clear polyisocyanate compositions again. By comparison, conventional materials are not clear upon being reheated. This is apparently due to dimer formation of the 4,4′-MDI in the conventional isocyanate compositions, which is accelerated when 4,4′-MDI is in the solid phase. In the isocyanate compositions of the present invention, the TXIB in the blend appears to improve the solubility of the MDI dimer, therefore improving the clarity of the unfrozen product.

As used herein, all molecular weights are number average molecular weights.

The freeze-stable aromatic diisocyanate having an NCO group content of 6 to 29% by weight comprises:
(I) from 60 to 95% by weight, based on 100% by weight of (I) and (II), of an aromatic diisocyanate having an NCO group content of 10% to 30%, and preferably 12% to 30% by weight and which contains one or more modifying group as described herein;
and
(II) from 5 to 40% by weight, based on 100% by weight of (I) and (II), of 2,2,4-trimethyl-1,3-pentanediol diisobutyrate.

These freeze-stable, allophanate-modified isocyanates of the present invention comprise:
(I) from 60 to 95% by weight, based on 100% by weight of (II) and (II), of an allophanate-modified diphenylmethane diisocyanate having an NCO group content of 18% to 30% and preferably 23% to 30% by weight;
and
(II) from 5 to 40% by weight, based on 100% by weight of (I) and (II), of 2,2,4-trimethyl-1,3-pentanediol diisobutyrate.

These freeze-stable prepolymers of allophanate-modified isocyanates of the present invention comprise:
(I) from 60 to 95% by weight, based on 100% by weight of (I) and (II), of a prepolymer of an allophanate-modified diphenylmethane diisocyanate having an NCO group content of 10% to 28%, and preferably 12% to 25% by weight;
and
(II) from 5 to 40% by weight, based on 100% by weight of (I) and (II), of 2,2,4-trimethyl-1,3-pentanediol diisobutyrate.

The freeze-stable carbodiimide-modified isocyanates of the present invention comprise:
(I) from 60 to 95% by weight, based on 100% by weight of (II) and (II), of a carbodiimide-modified diphenylmethane diisocyanate having an NCO group content of 23% to 30%, and preferably 25% to 30% by weight;
and
(II) from 5 to 40% by weight, based on 100% by weight of (I) and (II), of 2,2,4-trimethyl-1,3-pentanediol diisobutyrate.

In accordance with the present invention, the aromatic diisocyanate which contains one or more modifying group as described herein is present in an amount of at least 60% by weight and preferably at least 70% by weight, based on 100% by weight of (I) and (II), i.e. the blend. The aromatic diisocyanate is also typically present in an amount of no more than 95% by weight and preferably no more than 90% by weight, based on 100% by weight of (I) and (II), i.e. the blend. The quantity of the aromatic diisocyanate may vary between any combination of these upper and lower values, inclusive, e.g. from 60 to 95% and preferably from 70 to 90% by weight, based on 100% by weight of (I) and (II), i.e. the blend.

Suitable modifying groups for the aromatic diisocyanate of the present invention include allophanate groups, carbodiimide groups, uretonimine groups, dimer groups, biuret groups, isocyanurate (trimer) groups, urea groups and urethane groups. These modified diisocyanates have an NCO group content of from about 15% to about 30% by weight. Also suitable are prepolymers of such modified diisocyanates as described above. These prepolymers of the modified diisocyanates have NCO group contents of about 10% to about 28% by weight.

The amount of 2,2,4-trimethyl-1,3-pentanediol diisobutyrate present in accordance with the invention is at least 5%, and preferably 10% by weight, based on 100% by weight of the blend. The 2,2,4-trimethyl-1,3-pentanediol diisobutyrate is also typically present in an amount of no more than 40% by weight and preferably no more than 30% by weight, based on 100% by weight of the blend. Overall, the freeze-stable liquids of the invention may contain 2,2,4-trimethyl-1,3-pentanediol diisobutyrate in an amount ranging between any combination of these upper and lower values, inclusive, e.g. from 5% to 40% and preferably from 10% to 30% by weight, based on 100% by weight of the blend.

A particularly preferred starting (or unmodified) aromatic diisocyanate for the present invention is diphenylmethane diisocyanate. In accordance with the present invention, a particularly preferred diphenylmethane diisocyanate contains (i) from 0% to 23%, preferably from 0% to 10% by weight of the 2,4′-isomer of MDI; (ii) from 0% to 3%, preferably from 0% to 3% by weight of the 2,2′-isomer of MDI; and (iii) from 74% to 10%, preferably from 87% to 100% by weight of the 4,4′-isomer of MDI; with the sum of (i), (ii) and (iii) totaling 100% by weight of diphenylmethane diisocyanate.

As described herein the starting or unmodified aromatic diisocyanate component of the present invention is modified such that it contains one or more modifying groups disclosed herein, or a prepolymer of such a modified aromatic diisocyanate (i.e. prepolymers thereof).

A particularly preferred prepolymer is the prepolymer of allophanate-modified diphenylmethane diisocyanate. Suitable prepolymers of allophanate-modified diphenylmethane diisocyanate to be used herein comprise the reaction product of an allophanate-modified diphenylmethane diisocyanate, with a polyether polyol or a polyester polyol. These are described in detail below.

In accordance with the present invention, suitable compositions to be used herein include allophanate-modified MDI having an NCO group content of from 18% to 30%. The allophanate-modified MDI typically has an NCO group content of at least 18% by weight, preferably at least 23% by weight. The allophanate-modified MDI also typically has an NCO group content of no more than 30% by weight. Suitable allophanate-modified MDI of the present invention may have an NCO group content ranging between any combination of these upper and lower values, inclusive, e.g. from 18% to 30% by weight, preferably from 23% to 30% by weight.

Suitable allophanate-modified MDls for the present invention comprise the reaction product of:
(a) diphenylmethane diisocyanate containing (i) from about 0% to about 23% by weight of the 2,4′-isomer, (ii) from about 0% to about 3% by weight of the 2,2′-isomer and (iii) from about 74% to 100% by weight of the 4,4′-isomer, with the sum of the %'s by weight of the (i), (ii) and (iii) totaling 100% by weight of (a);
and
(b) an aliphatic alcohol or an aromatic alcohol in which the alcohols contains up to about 22 carbon atoms, and preferably monofunctional alcohols.

The diphenylmethane diisocyanate suitable for component (a) as described above for the present invention has the isomer distribution as set forth above, wherein the sum of the %'s by weight of 2,2′-isomer, 2,4′-isomer and 4,4′-isomer must total 100% by weight of the diphenylmethane diisocyanate (a). It is preferred that the diphenylmethane diisocyanate contains from about 0% to 10% by weight of the 2,4′-isomer, from about 0% to about 3% by weight of the 2,2′-isomer, and from 87% to 100% by weight of the 4,4′-isomer. In all instances, the sum of the %'s by weight of the 2,4′-isomer, the 2,2′-isomer and the 4,4′-isomer will total 100% by weight of (a), the diphenylmethane diisocyanate.

Suitable aliphatic alcohols to be used as component (b) can contain about 1 to 22 and preferably 1 to 8 carbon atoms. Illustrative but non-limiting examples of the aliphatic alcohols can be selected from the group consisting of straight and branched chain aliphatic alcohols, cycloaliphatic alcohols, aliphatic alcohols containing aromatic groups, aliphatic alcohols containing groups that do not react with isocyanates, e.g. ether groups and halogens such as bromine and chlorine. Specific but non-limiting examples of the suitable aliphatic alcohols include methanol, ethanol, isomeric propanols, isomeric butanols, isomeric pentanols, isomeric hexanols, isomeric heptanols, isomeric octanols, (e.g., 2-methyl 1-ethanol, 2-methyl-1-propanol, 2-methyl-1-butanol, 2-methyl-1-pentanol, 2-methyl-1-hexanol, etc.), cetylalcohol, cyclohexanol, 2-methoxyethanol, 2-methoxypropanol, 3-methoxybutanol, 2-bromoethanol, 2-bromopropanol, 2-bromobutanol, benzyl alcohol, 2-ethyl-1-hexanol, 2-butoxy ethanol etc.

Aliphatic alcohols for the present invention which are most preferred include the branched aliphatic alcohols such as, for example, 2-methyl-1-propanol(isobutanol). Preferred aliphatic alcohols to be used herein include, for example, 1-butanol, isobutanol, 1-propanol, 1-pentanol and 2-ethyl-1-hexanol.

Also suitable to be used as component (b) are aromatic alcohols which contain up to 22 carbon atoms. More specifically, these aromatic alcohols preferably contain from about 6 to about 18 carbon atoms, more preferably from about 6 to about 15. As used herein, the term aromatic alcohols refers those alcohols which have the alcoholic hydroxyl group attached to the aromatic group. Specific examples of the aromatic alcohols can be phenol, 1-naphthol, 2-naphthol, m-cresol, nonylphenol, isononylphenol, o-chlorophenol, p-bromophenol, m-nitrophenol and o-fluorophenol. Preferred aromatic alcohols include phenol, isononylphenol and m-cresol.

Suitable allophanate-modified diphenylmethane diisocyanates of the present invention can be prepared by, for example, the process disclosed in U.S. Pat. No. 5,319,053, the disclosure of which is herein incorporated by reference.

Suitable compositions also include prepolymers of allophanate-modified diphenylmethane diisocyanates. These prepolymers typically have an NCO group content of from 10% to 28%. The prepolymer of the allophanate-modified MDI typically has an NCO group content of at least 10% by weight, preferably at least 12% by weight, and more preferably at least 15% by weight. The prepolymer of the allophanate-modified MDI also typically has an NCO group content of no more than 28% by weight, preferably of no more than 25% by weight and more preferably of no more than 23% by weight. Suitable prepolymers of allophanate-modified MDI of the present invention may have an NCO group content ranging between any combination of these upper and lower values, inclusive, e.g. from 10% to 28% by weight, preferably from 12% to 25% by weight, and more preferably from 15% to 23% by weight.

As described above, prepolymers of allophanate-modified diphenylmethane diisocyanate are prepared by reacting the above described allophanate-modified diphenylmethane diisocyanates with at least one isocyanate-reactive component having a functionality of 1 to 6 and a molecular weight of 1,000 to 12,000. These isocyanate-reactive components include, for example, polyether polyols and polyester polyols.

These isocyanate-reactive components typically have a functionality of at least 1, preferably at least 1.5 and more preferably at least 1.7. These isocyanate-reactive components also typically have a functionality of no more than 6. The suitable isocyanate-reactive components may have a functionality ranging between any combination of these upper and lower values, inclusive, e.g. from 1 to 6, preferably from 1.5 to 6 and most preferably from 1.7 to 6.

These isocyanate-reactive components typically have a molecular weight of at least 1000, preferably at least 2000 and more preferably at least 3000. These isocyanate-reactive components also typically have a molecular weight of no more than 12,000. The suitable isocyanate-reactive components may have a molecular weight ranging between any combination of these upper and lower values, inclusive, e.g. from 1,000 to 12,000, preferably from 2,000 to 12,000 and more preferably from 3,000 to 12,000.

Suitable polyether polyols to be used herein for the prepolymers of the allophanate-modified MDI of the present invention include, for example, those which contain from 1 to 6 hydroxyl groups and have a (number average) molecular weight of from about 1,000 to about 12,000. These polyether polyols are prepared from a suitable starter compound with ethylene oxide and/or propylene oxide in a weight ratio of from 0:100 to 35:65, in the presence of a suitable catalyst. Suitable catalysts include, for example, basic catalysts such as potassium hydroxide, and DMC (double metal cyanide catalysts). These polyether polyols may either be conventional polyether polyols or low unsaturation polyether polyols.

The polyether polyols to be used herein typically have a functionality of at least 1, preferably at least 1.5 and more preferably at least 1.7. These polyether polyols also typically have a functionality of less than or equal to 6. The polyether polyols useful herein may have a functionality ranging between any combination of these upper and lower values, inclusive, e.g. from 1 to 6, preferably from 1.5 to 6.0, and more preferably from 1.7 to 6.0.

The polyether polyols suitable herein typically have a molecular weight of at least 1,000, preferably at least 2,000. These polyether polyols also typically have a molecular weight of less than or equal to 12,000 The polyether polyols useful herein may have a molecular weight ranging between any combination of these upper and lower values, inclusive, e.g. from 1,000 to 12,000, preferably from 2,000 to 12,000.

In addition, these polyether polyols are prepared by alkoxylating a suitable starter compound with ethylene oxide and propylene oxide in a weight ratio of from 0:100 to 35:65. In the preparation of these polyether polyols, ethylene oxide and propylene oxide are preferably used in a weight ratio of from 10 (EO):90 (PO) to 30 (EO):70 (PO), more preferably of from 12 (EO):88 (PO) to 20 EO):80 (PO), and most preferably of from (EO):85 (PO) to 20 (EO):80 (PO).

Suitable starter compounds for preparation of the polyether polyols include compounds such as, for example, ethylene glycol, 1,2- and 1,3-propylene glycol, 1,3-, 1,4- and 2,3-butylene glycol, glycerol, trimethylolethane, trimethyolpropane, neopentyl glycol, pentaerythritol, mannitol, sorbitol, diethylene glycol, dipropylene glycol, dibutylene glycol, cyclohexanedimethanol, 2-methyl-1,3-propanediol, 2-methyl-2,4-pentanediol, 2,2,4-trimethyl-1,3-pentanediol, 3-methyl-5-ethyl-2,4-heptanediol, triethylene glycol, tripropylene glycol, tributylene glycol, tetraethylene glycol, water, methanol, ethanol, 1,2,6-hexanetriol, 1,2,4-butanetriol, phenol, isononylphenol, resorcinol, hydroquinone, 1,1,1- and 1,1,2-tris-(hydroxylphenyl)ethane, etc., and mixtures thereof. Preferred starter compounds for the polyether polyols include propylene glycol, glycerol, water, ethylene glycol, diethylene glycol, trimethylolpropane, pentaerythritol and sorbitol.

Suitable polyester polyols to be used in preparing prepolymers of the allophanate-modified MDI of the present invention include, for example, those which contain from 1.5 to 3.0 hydroxyl groups and have a (number average) molecular weight of from about 500 to about 3000. These polyester polyols are typically prepared by reacting of one or more di- or poly-hydric alcohols with one or more di- or poly-carboxylic acids or derivatives thereof. The polyesters may be catalyzed or uncatalyzed.

The polyester polyols to be used herein typically have a functionality of at least 1.5, preferably at least 2.0. These polyester polyols also typically have a functionality of less than or equal to 3.0, preferably less than or equal to 2.5. The polyester polyols useful herein may have a functionality ranging between any combination of these upper and lower values, inclusive, e.g. from 1.5 to 3.0, preferably from 2.0 to 2.5.

The polyester polyols suitable herein typically have a molecular weight of at least 500, preferably at least 1,000. These polyester polyols also typically have a molecular weight of less than or equal to 3000, preferably less than or equal to 2,800 and more preferably less than or equal to 2,500. The polyester polyols useful herein may have a molecular weight ranging between any combination of these upper and lower values, inclusive, e.g. from 500 to 3,000, preferably from 1,000 to 2,800, and more preferably from 1,000 to 2,500.

Preferred polyester polyols include those which are prepared by the reaction of one or more di- or poly-hydric alcohols with one or more di- or poly-carboxylic acids or derivatives thereof. Suitable polyhydric alcohols include for example, in particular diols, include: ethanediol (ethylene glycol), diethylene glycol, 1,2- and 1,3-propanediol, dipropylene glycol, 1,4-butanediol, 1,3-butanediol, 2-methyl-1,3-propanediol, 1,4-cyclohexanedimethanol (CHDM), neopentyl glycol, 2,2,4-trimethyl-1,3-pentanediol (TMPD), 1,5-pentanediol, 1,6-hexanediol, 1,10-decanediol, glycerol and trimethylolpropane. Preference is given to ethanediol, propylene glycol, dipropylene glycol, neopentyl glycol, diethylene glycol, 1,4-butanediol, 1,5-pentanediol, 1,6-hexanediol or mixtures of at least two of the diols mentioned, in particular mixtures of 1,4-butanediol and ethanediol. Examples of suitable di- and poly-carboxylic acids include adipic acid, succinic acid, glutaric acid, suberic acid, azelaic acid, sebacic acid, decanedicarboxylic acid, maleic acid, fumaric acid, dimeric and/or trimeric fatty acids, and preferably adipic acid, phthalic acid, isophthalic acid, terephthalic acid, and the isomeric naphthalenedicarboxylic acids. The di- and poly-carboxylic acids may be used either individually or as a mixture with one another. Instead of the free dicarboxylic acids, the corresponding dicarboxylic acid derivatives, for example dicarboxylic esters of alcohols having from 1 to 4 carbon atoms or dicarboxylic anhydrides like phthalic anhydride, hexahydrophthalic anhydride, trimellitic anhydride may also be used. Preference is given to adipic acid and using dicarboxylic acid mixtures of succinic, glutaric and adipic acid, and in particular mixtures of phthalic acid and/or phthalic anhydride and adipic acid, mixtures of phthalic acid/anhydride, isophthalic acid and adipic acid, and mixtures of terephthalic acid and adipic acid.

In accordance with the present invention, the prepolymers of the allophanate-modified diphenylmethane diisocyanate as described above are blended with 2,2,4-trimethyl-1,3-pentanediol diisobutyrate to form a freeze-stable isocyanate composition.

A process for preparing the freeze stable allophanate-modified polyisocyanate compositions of the present invention includes the following steps:

Diphenylmethane diisocyanate is charged to a reactor and heated to about 60° C. under agitation. A calculated amount of the chosen alcohol is added, followed by the catalytic amounts of zinc acetylacetonate or other suitable catalyst. The reaction mixture is stirred at 90° C. until the calculated NCO content is reached (i.e., about 18 to about 30% NCO). At this time, a small amount of benzoyl chloride (or other suitable stopper) is added to deactivate the catalyst. The allophanate-modified MDI is subsequently cooled to 60° C. If a prepolymer is to be made, after cooling of the allophanate-modified MDI, a calculated amount of a polyether polyol is added and reacted with the allophanate-modified MDI until the calculated isocyanate content of the prepolymer is reached (i.e., about 10 to about 28% NCO). During cooling to 25° C., the desired amount of 2,2,4-trimethyl-1,3-pentanediol diisobutyrate compound is added (i.e., from 5 to 40% by weight, based on 100% by weight of components (A) and (B)). The final isocyanate content and the viscosity are determined and the product is stored until used in the preparation of a polyurethane.

The blends of the allophanate-modified diphenylmethane diisocyanate, with 2,2,4-trimethyl-1,3-pentanediol diisobutyrate (TXIB) typically have NCO group contents of at least about 11% and preferably of at least about 14% NCO. These blends also typically have NCO group contents of no more than about 28.5% and preferably no more than about 28% NCO. The blends of allophanate-modified MDI with TXIB may have an NCO group content ranging between any combination of these upper and lower values, inclusive, e.g. from about 11% to about 28.5% NCO, and preferably from 14% to about 28% NCO. In addition, the viscosity of the original allophanate-modified MDI product may be reduced by more than half in the final blend.

The blends of the prepolymers of the allophanate-modified diphenylmethane diisocyanate with 2,2,4-trimethyl-1,3-pentanediol diisobutyrate (TXIB) typically have NCO group contents of at least about 6% NCO and preferably at least about 8% NCO. These blends also typically have NCO group contents of no more than about 26.5%, and preferably no more than about 23% NCO. In addition, these blends of prepolymers of allophanate-modified MDI with TXIB may have an NCO group content ranging between any combination of these upper and lower values, inclusive, e.g. from 6% to 26.5% and preferably from about 8% to about 23% NCO. In addition, the viscosity of the original allophanate-modified MDI product may be reduced by more than half in the final blend.

In accordance with the present invention, the blends of the carbodiimide-modified diphenylmethane diisocyanate with 2,2,4-trimethyl-1,3-pentanediol diisobutyrate (TXIB) typically have an NCO group content of from 13.5% to 28.5%. These blends of carbodiimide-modified MDI with TXIB typically have an NCO group content of at least 13.5% by weight, preferably at least 16% by weight, and more preferably at least 18% by weight. The blends of carbodiimide-modified MDI with TXIB also typically have an NCO group content of no more than 28.5% by weight, preferably of no more than 27% by weight and more preferably of no more than 25% by weight. Suitable blends of carbodiimide-modified MDI with TXIB in accordance with the present invention may have an NCO group content ranging between any combination of these upper and lower values, inclusive, e.g. from 13.5% to 28.5% by weight, preferably from 16% to 27% by weight, and more preferably from 18% to 25% by weight.

Carbodiimide-modified diphenylmethane diisocyanates of the present invention are typically prepared by, for example, heating the 4,4′ isomer of diphenyl diisocyanate in the presence of a suitable carbodiimidization catalyst such as a phospholine oxide. Additional process details are known and described in, for example, The Polyurethanes Book, John Wiley & Sons, LTD, 2002, pp. 120-121.

The examples illustrate that another advantage of using TXIB in aromatic diisocyanates which contain at least one modifying group as described herein is that if such blends become turbid or even solidify due to exposure to cold temperatures for extended periods of time, the blends can be returned to a perfectly clear state by reheating. This is believed to be due to the increased solubility of MDI dimer, whose formation is accelerated when 4,4′-MDI is in the solid state, in TXIB.

All molecular weights disclosed herein are number average molecular weights unless otherwise stated.

The following examples further illustrate details for the preparation and use of the compounds of this invention. The invention, which is set forth in the foregoing disclosure, is not to be limited either in spirit or scope by these examples. Those skilled in the art will readily understand that known variations of the conditions and processes of the following preparative procedures can be used to prepare these compounds. Unless otherwise noted, all temperatures are degrees Celsius and all parts and percentages are parts by weight and percentages by weight, respectively.

### EXAMPLES

The following materials were used in the working examples:
Isocyanate A: diphenylmethane diisocyanate comprising less than 2% by weight of the 2,4′-isomer, more than 98% by weight of the 4,4′-isomer and less than 0.5% by weight of the 2,2′-isomer and having an NCO group content of about 33.5%
Alcohol A: isobutyl alcohol
Polyol A: a propylene glycol started polypropylene oxide polyether polyol having a 20% ethylene oxide cap, a molecular weight of about 4000 and an OH number of about 28
Polyester A: a polyester polyol prepared from adipic acid, 1,4-butanediol and ethylene glycol having a molecular weight of 2000 and a functionality of 2.0
TPG: tripropylene glycol
TXIB: 2,2,4-trimethyl-1,3-pentanediol diisobutyrate

The modified aromatic diisocyanates of the invention were prepared as described below.

### Preparation of a Liquid Allophanate-Modified Isocyanate (Allophanate 1):

53.24 parts by weight of Isocyanate A were added to a reactor at 45° C., followed by the addition of 0.0056 parts by weight of zinc acetylacetonate catalyst at 45° C. Then, 1.6 parts by weight of Alcohol A were added to the reactor at 45° C., and the mixture reacted at 90° C. for 90 minutes. At this time, 0.0088 parts by weight of benzoyl chloride (a catalyst stopper) were added at 50° C. The NCO group content of the allophanate-modified diphenylmethane diisocyanate was about 29% by weight. The allophanate-modified diphenylmethane diisocyanate is referred throughout the examples as Allophanate 1.

### Preparation of a Prepolymer (Prepolymer 1) of the Liquid Allophanate-Modified Diphenylmethane Diisocyanate (i.e Allophanate 1 Above):

To the reactor containing 54.84 parts of allophanate-modified diphenylmethane diisocyanate having an NCO group content of about 29% by weight, was added 25.16 parts by weight of Polyol A at 50° C. and the mixture was reacted at 60° C. for 2 hrs. This resulted in a prepolymer of an allophanate-modified diphenylmethane diisocyanate in which the NCO group content of the prepolymer is 19% by weight. This prepolymer is referred to throughout the examples as Prepolymer 1.

### Preparation of a Liquid Carbodiimide-Modified Isocyanate (Carbodiimide 1):

100 parts by weight of Isocyanate A were added to a reactor at 40° C., followed by the addition of 3 ppm of methyl phospholine oxide catalyst at 25° C. This was allowed to react at 75° C. until a liquid carbodiimide-modified diphenylmethane diisocyanate having an NCO group content of about 29.8% by weight was formed. A stopper, trimethylsilyl trifluoromethylsulfonate at 50 ppm is added and the reaction temperature is maintained for another five hours. Due to subsequent dimerization of the carbodiimide functional groups with free NCO groups, uretonimine structures are formed. The final product had an NCO group content of about 29.5%, a functionality of about 2.2 and a viscosity of 50 mPa·s at 25° C. This product is referred to throughout the examples as Carbodiimide 1.

### Freeze-Stable Liquid Isocyanate Compositions in Accordance With the Present Invention Were Made by Following Procedure:

For each freeze-stable isocyanate composition, the required quantity of the above described isocyanate compositions (Allophanate 1, Prepolymer 1 and Carbodiimide 1) were cooled to 25° C. To the cooled isocyanate compositions, were added 20 parts by weight of TXIB. The resulting liquid isocyanate compositions were freeze-stable isocyanates in accordance with the present invention. Characteristic properties of each freeze-stable isocyanate such as NCO group contents, viscosity, etc. are set forth in Table 1.

TABLE 1

| | Isocyanates | | | | | |
|---|---|---|---|---|---|---|
| | | Freeze- | | Freeze- | | Freeze- |
| | Iso | Stable | | Stable | Iso | Stable |
| | 1* | Iso 1 | Iso 2* | Iso 2 | 3* | Iso 3 |
| Allophanate | 100 | 80 | | | | |
| 1 (pbw) | | | | | | |
| Prepolymer 1 | | | 100 | 80 | | |
| (pbw) | | | | | | |
| Carbodiimide | | | | | 100 | 80 |
| 1 (pbw | | | | | | |
| TXIB (pbw) | | 20 | | 20 | | 20 |
| % NCO by | 29 | 23.2 | 19 | 15.2 | 29.5 | 23.6 |
| wt. | | | | | | |
| Viscosity at | 40 | Not | 475 | 174 | 50 | Not |
| 25° C. | | measured | | | | measured |
| (mPa · s) | | | | | | |

*Isos 1, 2 and 3 represent isocyanate compositions with no TXIB. These are comparative examples.

Each of the isocyanate compositions in Table 1 was then subjected to temperatures ranging from −5° C. to 30° C. for various time periods to determine the effect (if any) of this exposure on the clarity of each isocyanate composition. Cloudiness, the presence of any precipitated solids, and freezing of the composition was also noted, and the time required at each temperature for this to occur.

TABLE 2

| | | Freeze- | | Freeze-Stable |
|---|---|---|---|---|
| Example | Iso 1* | Stable Iso 1 | Iso 2* | Iso 2 |
| 35° C. | remains | remains | clear >6 | clear >6 |
| | clear after | clear after | months | months |
| | 28 days | 28 days | | |
| 25° C. | cloudy in 24 | remains | clear for >6 | clear for >6 |
| | hours | clear after | months | months |
| | | 28 days | | |
| 20° C. | cloudy in 24 | cloudy in 24 | cloudy w/ | clear for >6 |
| | hours | hours | ppt. solids | months |
| | | | after 30 | |
| | | | days | |
| 15° C. | ND | ND | cloudy w/ | clear for >6 |
| | | | ppt. solids | months |
| | | | after 30 | |
| | | | days | |
| 10° C. | ND | ND | cloudy with | slightly cloudy |
| | | | ppt. solids | on day 6; |
| | | | at 20 hours; | increased |
| | | | frozen at 64 | cloudiness on |
| | | | hours⁽¹⁾ | day 10 |
| −5° C. | ND | ND | ND | frozen on day |
| | | | | 3⁽²⁾ |

*Isos 1 and 2 are comparative isocyanate compositions that did not contain any TXIB.
⁽¹⁾Iso 2 (a prepolymer of an allophanate-modified diphenylmethane diisocyanate) did not become clear when unfrozen. This is believed to be caused by MDI dimer formation which easily forms in the solid state. Dimers of MDI are not soluble in the unfrozen isocyanate
⁽²⁾Freeze-stable Iso 2 returned to a perfectly clear state after being frozen when heated overnight at 60° C. (i.e. 140° F.). This isocyanate composition remained clear when cooled down to room temperature (i.e. about 25° C.).

The above data shows that TXIB solubilizes the dimer formed when the 4,4′-MDI was in the solid state in Freeze-Stable Iso 2. The neat prepolymer (i.e. Iso 2) contained suspended solids upon re-melting which could result in plugged filters when used with molding equipment to make polyurethane parts.

TABLE 3

| Example | Iso 3* | Freeze-Stable Iso 3 |
|---|---|---|
| 10° C. | frozen in less than 3 | clear liquid for >4 |
| | days | weeks |

*Iso 3 is a comparative isocyanate compositions that did not contain any TXIB

Isocyanates 4 and 5 are prepolymers of isocyanates. The preparation of Isocyanates 4 and 5 was as follows:

Isocyanate 4: A blend of 56 parts by weight of Isocyanate A and 6 parts by weight of Carbodiimide 1 (a carbodiimide-modified MDI having an NCO group content of about 29.5% and a functionality of about 2.2) was prepared at 40° C. p-Nitrobenzoyl chloride (0.008 parts by weight) was added to the blend. Then, 38 parts by weight of Polyester A was added to the blend and the reactants were heated to 65° C. This reaction temperature was maintained until a % NCO of 19.0% by weight was attained. The reaction product was cooled to 50° C. and transferred to storage. The resultant prepolymer had a final % NCO group content of 18.9% by weight, a functionality of 2.015 and a viscosity of 1,100 mPa·s at 25° C.

Isocyanate 5: Isocyanate 5 was prepared by adding 86.2 parts by weight of Isocyanate A to a reactor at 40° C., followed by adding 13.8 parts by weight of TPG. The reactants were heated to 65° C. and allowed to react until a % NCO group content of 23.0% by weight was attained. The product was cooled. The resultant prepolymer had a functionality of 2.0, a % NCO group content of 22.9% by weight and a viscosity of 675 mPa·s at 25° C.

### Freeze-Stable Liquid Isocyanate Compositions in Accordance With the Present Invention Were Made by Following Procedure:

For each freeze-stable isocyanate composition set forth in Table 4, the required quantity of the above described isocyanate compositions (Isocyanate 4 or Isocyanate 5) were cooled to 25° C. To the cooled isocyanate compositions, were added 20 parts by weight of TXIB. The resulting liquid isocyanate compositions were freeze-stable isocyanates in accordance with the present invention. Characteristic properties of each freeze-stable isocyanate such as NCO group contents, viscosity, etc. are set forth in Table 4.

TABLE 4

| | Isocyanates | | | |
|---|---|---|---|---|
| | | Freeze- | | Freeze- |
| | Iso 4* | Stable Iso 4 | Iso 5* | Stable Iso 5 |
| Isocyanate 4 (pbw) | 100 | 80 | | |
| Isocyanate 5 (pbw) | | | 100 | 80 |
| TXIB (pbw) | 0 | 20 | 0 | 20 |
| % NCO by wt. | 19% | 15.1% | 23% | 18.3% |
| Viscosity at 25° C. | 1100 | ND | 675 | ND |
| (mPa · s) | | | | |

ND: not determined

Each of the isocyanate compositions in Table 4 was then subjected to temperatures of −5° C. for various time periods to determine the effect (if any) of this exposure on the clarity of each isocyanate composition. Cloudiness, the presence of any precipitated solids, and freezing of the composition was also noted, and the time required for this to occur. The results are set forth in Table 5.

TABLE 5

Isocyanates

| | | Freeze- | | Freeze- |
|---|---|---|---|---|
| | Iso 4* | Stable Iso 4 | Iso 5* | Stable Iso 5 |
| 2 Hours | frozen | clear | frozen | clear |
| 8 Hours | | slightly | | slightly |
| | | cloudy | | cloudy |
| 10 Hours | | turbid | | very turbid |
| 12 Hours | | frozen | | frozen |

The frozen samples of Iso 4 and Iso 5 (comparative examples) were later heated at 60° C. (i.e. 140° F.) overnight. Upon cooling down to room temperature (i.e. about 25° C.), each of these Isos became cloudy.

The frozen samples of Freeze-Stable Iso 4 and Freeze-Stable Iso 5 were later heated at 60° C. (i.e. 140° F.) overnight. Each of these became perfectly clear and remained clear when cooled down to room temperature (i.e. about 25° C.).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A freeze-stable aromatic diisocyanate composition having an NCO group content of about 6 to about 29% by weight which comprises:
(I) from 60% to 95% by weight, based on 100% by weight of (I) and (II), of an aromatic diisocyanate which is modified to contain at least one of the following groups: allophanate groups, carbodiimide groups, uretonimine groups, biuret groups, dimer groups, isocyanurate groups, urea groups and/or urethane groups, in which the modified diisocyanate has an NCO group content of from 15% to 30% by weight, or one or more prepolymers of said modified aromatic diisocyanates, in which said prepolymer has an NCO group content of from 10% to 28% by weight;
and
(II) from 5 to 40% by weight, based on 100% by weight of (I) and (II), of 2,2,4-trimethyl-1,3-pentanediol diisobutyrate.

2. The freeze-stable aromatic diisocyanate of claim 1, wherein
(I) said aromatic diisocyanate comprises:
(a) diphenylmethane diisocyanate having an NCO group content of 31% to 33.5% by weight and comprising (i) 0% to 23% by weight of 2,4′-diphenylmethane diisocyanate, (ii) 0% to 3% by weight of 2,2′-diphenylmethane diisocyanate and (iii) 74% to 100% by weight of 4,4′-diphenylmethane diisocyanate, with the sum of the %'s by weight of (a)(i), (a)(ii) and (a)(iii) totaling 100% by weight of said diphenylmethane diisocyanate.

3. The freeze-stable aromatic diisocyanate of claim 2, wherein
(I) said aromatic diisocyanate comprises an allophanate modified diphenylmethane diisocyanate having an NCO group content of from 18% to 30%, which comprises the reaction product of:
(a) diphenylmethane diisocyanate comprising (i) from 0% to 23% by weight of the 2,4′-isomer, (ii) from 0% to 3% by weight of the 2,2′-isomer and (iii) from 74% to 100% by weight of the 4,4′-isomer, with the sum of the %'s by weight of (a)(i), (a)(ii) and (a)(iii) totaling 100% by weight of said diphenylmethane diisocyanate,
and
(b) an aliphatic alcohol or an aromatic alcohol, wherein the alcohol contains up to about 22 carbon atoms.

4. The freeze-stable aromatic diisocyanate of claim 1, which comprises:
(I) from 70 to 90% by weight of an allophanate modified diphenylmethane diisocyanate having an NCO group content of 23% to 30% by weight, and which comprises the reaction product of:
(a) diphenylmethane diisocyanate having an NCO group content of 31% to 33.5% by weight and comprising (i) from 0% to 10% by weight of the 2,4′-isomer, (ii) from 0% to 3% by weight of the 2,2′-isomer and (iii) from 87% to 100% by weight of the 4,4′-isomer, with the sum of the %'s by weight of (a)(i), (a)(ii) and (a)(iii) totaling 100% by weight of said diphenylmethane diisocyanate,
and
(b) an aliphatic alcohol or an aromatic alcohol, wherein the alcohol contains up to about 22 carbon atoms;
and
(II) from 10 to 30% by weight of 2,2,4-trimethyl-1,3-pentanediol diisobutyrate.

5. The freeze-stable aromatic diisocyanate of claim 1, which comprises:
(I) from 60 to 95% by weight, based on 100% by weight of (I) and (II), of an aromatic diisocyanate which comprises a prepolymer of an allophanate-modified diphenylmethane diisocyanate having an NCO group content of from 10% to 28% by weight and which comprises the reaction product of:
(A) an allophanate-modified diphenylmethane diisocyanate having an NCO group content of 18% to 30% by weight and which comprises the reaction product of:
(a) diphenylmethane diisocyanate having an NCO group content of 31% to 33.5% by weight and comprising (i) from 0% to 23% by weight of the 2,4′-isomer, (ii) from 0% to 3% by weight of the 2,2′-isomer and (iii) from 74% to 100% by weight of the 4,4′-isomer, with the sum of the %'s by weight of (a)(i), (a)(ii) and (a)(iii) totaling 100% by weight of said diphenylmethane diisocyanate,
and
(b) an aliphatic alcohol or an aromatic alcohol, wherein the alcohol contains up to about 22 carbon atoms;
with
(B) a polyether polyol containing from 1 to 6 hydroxyl groups and having a molecular weight of from 1,000 to 12,000, in which the polyether polyol is prepared from a suitable starter compound with ethylene oxide and propylene oxide in a weight ratio of 0:100 to 35:65;
and
(II) from 5 to 40% by weight, based on 100% by weight of (I) and (II), of 2,2,4-trimethyl-1,3-pentanediol diisobutyrate.

6. The freeze-stable aromatic diisocyanate of claim 5, which comprises:
(I) from 70 to 90% by weight based on 100% by weight of (I) and (II), of a prepolymer of an allophanate-modified diphenylmethane diisocyanate;
and
(II) from 10 to 30% by weight, based on 100% by weight of (I) and (II), of 2,2,4-trimethyl-1,3-pentanediol diisobutyrate.

7. The freeze-stable aromatic diisocyanate of claim 5, in which
(I) said prepolymer of an allophanate-modified diphenylmethane diisocyanate has an NCO group content of from 12% to 25% by weight and comprises the reaction product of:
(A) an allophanate-modified diphenylmethane diisocyanate having an NCO group content of 23% to 30% by weight and which comprises the reaction product of:
(a) diphenylmethane diisocyanate comprising (i) from 0% to 10% by weight of the 2,4′-isomer, (ii) from 0% to 3% by weight of the 2,2′-isomer and (iii) from 87% to 100% by weight of the 4,4′-isomer, with the sum of the %'s by weight of (a)(i), (a)(ii) and (a)(iii) totaling 100% by weight of said diphenylmethane diisocyanate,
and
(b) an aliphatic alcohol or an aromatic alcohol, wherein the alcohol contains up to about 22 carbon atoms;
with
(B) a polyether polyol containing from 1.5 to 6 hydroxyl groups and having a molecular weight of from 2,000 to 12,000, in which the polyether polyol is prepared from a suitable starter compound with ethylene oxide and propylene oxide in a weight ratio of 10:90 to 30:70.

8. The freeze-stable aromatic diisocyanate of claim 1, wherein:
(I) said aromatic diisocyanate comprises a carbodiimide-modified diphenylmethane diisocyanate having an NCO group content of 23% to 30% by weight.

9. A process for the preparation of a freeze-stable aromatic diisocyanate composition having an NCO group content of about 6% to about 29% by weight, which comprises:
(1) blending
(I) from 60% to 95% by weight, based on 100% by weight of (I) and (II), of an aromatic diisocyanate which is modified to contain one or more of the following modifying groups: allophanate groups, carbodiimide groups, uretonimine groups, biuret groups, dimer groups, isocyanurate groups, urea groups and/or urethane groups, in which the modified aromatic diisocyanate has an NCO group content of 15% to 30% by weight, or one or more prepolymers of said modified aromatic diisocyanates in which said prepolymer has an NCO group content of 10% to 28% by weight;
with
(II) from 5 to 40% by weight, based on 100% by weight of (I) and (II), of 2,2,4-trimethyl-1,3-pentanediol diisobutyrate.

10. The process of claim 9, wherein (I) said aromatic diisocyanate comprises: (a) diphenylmethane diisocyanate having an NCO group content of 31% to 33.5% by weight and comprising (i) 0% to 23% by weight of 2,4′-diphenylmethane diisocyanate, (ii) 0% to 3% by weight of 2,2′-diphenylmethane diisocyanate and (iii) 74% to 100% by weight of 4,4′-diphenylmethane diisocyanate, with the sum of the %'s by weight of (a)(i), (a)(ii) and (a) (iii) totaling 100% by weight of (a) said diphenylmethane diisocyanate.

11. The process of claim 10, wherein (I) said aromatic diisocyanate comprises an allophanate modified diphenylmethane diisocyanate having an NCO group content of from 18% to 30%, which comprises the reaction product of:
(a) diphenylmethane diisocyanate comprising (i) from 0% to 23% by weight of the 2,4′-isomer, (ii) from 0% to 3% by weight of the 2,2′-isomer and (iii) from 74% to 100% by weight of the 4,4′-isomer, with the sum of the %'s by weight of (a)(i), (a)(ii) and (a)(iii) totaling 100% by weight of (a) said diphenylmethane diisocyanate,
and
(b) an aliphatic alcohol or an aromatic alcohol, wherein the alcohol contains up to about 22 carbon atoms.

12. The process of claim 9, which comprises (1) blending:
(I) from 70 to 90% by weight of an allophanate modified diphenylmethane diisocyanate having an NCO group content of 23% to 30% by weight, and which comprises the reaction product of:
(a) diphenylmethane diisocyanate having an NCO group content of 31% to 33.5% by weight and comprising (i) from 0% to 10% by weight of the 2,4′-isomer, (ii) from 0% to 3% by weight of the 2,2′-isomer and (iii) from 87% to 100% by weight of the 4,4′-isomer, with the sum of the %'s by weight of (a)(i), (a)(ii) and (a)(iii) totaling 100% by weight of said diphenylmethane diisocyanate,
and
(b) an aliphatic alcohol or an aromatic alcohol, wherein the alcohol contains up to about 22 carbon atoms;
with
(II) from 10 to 30% by weight of 2,2,4-trimethyl-1,3-pentanediol diisobutyrate.

13. The process of claim 9, which comprises (1) blending:
(I) from 60% to 95% by weight, based on 100% by weight of (I) and (II), of an aromatic diisocyanate which comprises a prepolymer of an allophanate-modified diphenylmethane diisocyanate having an NCO group content of from 10% to 28% by weight and which comprises the reaction product of:
(A) an allophanate-modified diphenylmethane diisocyanate having an NCO group content of 18% to 30% by weight and which comprises the reaction product of:
(a) diphenylmethane diisocyanate having an NCO group content of 31% to 33.5% by weight and comprising (i) from 0% to 23% by weight of the 2,4′-isomer, (ii) from 0% to 3% by weight of the 2,2′-isomer and (iii) from 74% to 100% by weight of the 4,4′-isomer, with the sum of the %'s by weight of (a)(i), (a)(ii) and (a)(iii) totaling 100% by weight of said diphenylmethane diisocyanate,
and
(b) an aliphatic alcohol or an aromatic alcohol, wherein the alcohol contains up to about 22 carbon atoms;
with
(B) a polyether polyol containing from 1 to 6 hydroxyl groups and having a molecular weight of from 1,000 to 12,000, in which the polyether polyol is prepared from a suitable starter compound with ethylene oxide and propylene oxide in a weight ratio of 0:100 to 35:65;
with
(II) from 5 to 40% by weight, based on 100% by weight of (I) and (II), of 2,2,4-trimethyl-1,3-pentanediol diisobutyrate.

14. The process of claim 13, which comprises (1) blending:
(I) from 70 to 90% by weight based on 100% by weight of (I) and (II), of a prepolymer of an allophanate-modified diphenylmethane diisocyanate;
with
(II) from 10 to 30% by weight, based on 100% by weight of (I) and (II), of 2,2,4-trimethyl-1,3-pentanediol diisobutyrate.

15. The process of claim 13, in which (I) said prepolymer of an allophanate-modified diphenylmethane diisocyanate has an NCO group content of from 12% to 25% by weight and comprises the reaction product of:
(A) an allophanate-modified diphenylmethane diisocyanate having an NCO group content of 23% to 30% by weight and which comprises the reaction product of:
(a) diphenylmethane diisocyanate comprising (i) from 0% to 10% by weight of the 2,4′-isomer, (ii) from 0% to 3% by weight of the 2,2′-isomer and (iii) from 87% to 100% by weight of the 4,4′-isomer, with the sum of the %'s by weight of (a)(i), (a)(ii) and (a)(iii) totaling 100% by weight of said diphenylmethane diisocyanate,
and
(b) an aliphatic alcohol or an aromatic alcohol, wherein the alcohol contains up to about 22 carbon atoms;
with
(B) a polyether polyol containing from 1.5 to 6 hydroxyl groups and having a molecular weight of from 2,000 to 12,000, in which the polyether polyol is prepared from a suitable starter compound with ethylene oxide and propylene oxide in a weight ratio of 10:90 to 30:70.

16. The process of claim 9, wherein (I) said aromatic diisocyanate comprises a carbodiimide-modified diphenylmethane diisocyanate having an NCO group content of 23% to 30% by weight.
